(19) United States
(12) Patent Application Publication
(10) Pub. No.: US 2026/0355916 A1
(43) Pub. Date: Nov. 12, 2026

(54) MAGAZINE ATTACHMENT AND DETACHMENT METHOD AND MAGAZINE ATTACHMENT AND DETACHMENT SYSTEM

(71) Applicant: DAIFUKU CO., LTD., Osaka-shi (JP)

(72) Inventors: Shingo HASHIMOTO, Hino-cho (JP); Kaname FUJIMORI, Hino-cho (JP); Takashi KIMURA, Hino-cho (JP)

(73) Assignee: DAIFUKU CO., LTD., Osaka-shi (JP)

(21) Appl. No.: 19/666,657

(22) Filed: May 4, 2026

(30) Foreign Application Priority Data
May 12, 2025 (JP) 2025-079982

(51) Int. Cl. B25B 23/04; B25J 11/00

(52) U.S. Cl. CPC B25B 23/04; B25J 11/007

(57) ABSTRACT

In a magazine attachment and detachment method, a magazine is attached to and detached from a retention body by moving a robot arm device provided with: a nutrunner that performs a fastening operation using a bolt; the magazine in which the bolt is loaded; a supply device that supplies the bolt from the magazine to the nutrunner; and the retention body that retains the magazine. The magazine attachment and detachment method includes: a first movement step of moving the retention body between a coupling position at which the magazine attached to the retention body is coupled to a hanger that is fixed at a predetermined position and a non-coupling position at which the magazine is not coupled to the hanger; and a second movement step of moving the retention body between the coupling position and a detachment position at which the magazine is detached from the retention body.

This Nonprovisional application claims priority under 35 U.S.C. § 119 on Patent Application No. 2025-079982 filed in Japan on May 12, 2025, the entire contents of which are hereby incorporated by reference.

### TECHNICAL FIELD

The present invention relates to a magazine attachment and detachment method for attaching and detaching a magazine, and the like.

### BACKGROUND ART

A magazine loaded with articles to be supplied, such as components, is used in a state of being attached to an attachment part. When the articles in the magazine are supplied and run out, it is necessary to attach and detach the magazine to and from a retention part that retains the magazine, in order to replace the magazine.

For example, Patent Literature 1 discloses a bolt supply device that, when a rotary magazine loaded with a plurality of bolts becomes empty, supplies and loads bolts one by one into the rotary magazine with use of a part feeder. In loading of bolts into the rotary magazine, a robot module that rotates a turret for transferring bolts within the rotary magazine is separated from the rotary magazine, and then a shuttle transfer part moves the rotary magazine to the part feeder.

### CITATION LIST

### Patent Literature

### Patent Literature 1

Japanese Patent Application Publication, Tokukai, No. 2022-80282

### SUMMARY OF INVENTION

### Technical Problem

In the bolt supply device described above, the shuttle transfer part is required as driving means in order to move the rotary magazine to the part feeder. This results in a problem that the configuration of the bolt supply device is complex.

An object of an aspect of the present invention is to attach and detach a magazine without using driving means.

### Solution to Problem

In order to attain the object, a magazine attachment and detachment method in accordance with an aspect of the present invention is a method for attaching and detaching a magazine to and from a retention body by a robot arm device provided with (i) the magazine in which an article to be supplied is loaded, (ii) a supply device that supplies the article from the magazine to a work device, (iii) the work device that performs work using the article, and (iv) the retention body that retains the magazine, the method including: a first movement step of moving the retention body between (i) a coupling position at which the magazine attached to the retention body is coupled to a coupling body that has a structure for coupling to the magazine and that is fixed at a predetermined position and (ii) a non-coupling position at which the magazine attached to the retention body is not coupled to the coupling body, by moving the robot arm device relative to the coupling body; and a second movement step of moving the retention body between the coupling position and a detachment position at which the magazine is detached from the retention body, by moving the robot arm device relative to the coupling body.

In order to attain the object, a magazine attachment and detachment system in accordance with an aspect of the present invention includes: a robot arm device provided with (i) a magazine in which an article to be supplied is loaded, (ii) a supply device that supplies the article from the magazine to a work device, (iii) the work device that performs work using the article, and (iv) a retention body that retains the magazine; a coupling body that has a structure for coupling to the magazine and is fixed at a predetermined position; and a control device that controls movement of the robot arm device relative to the coupling body so as to move the retention body between a coupling position at which the magazine attached to the retention body is coupled to the coupling body and a non-coupling position at which the magazine attached to the retention body is not coupled to the coupling body and move the retention body between the coupling position and a detachment position at which the magazine is detached from the retention body.

### Advantageous Effects of Invention

According to an aspect of the present invention, attaching and detaching of the magazine to and from the retention body is performed by movement of the robot arm device. This makes it possible to attach and detach the magazine without using driving means for attaching and detaching the magazine.

### BRIEF DESCRIPTION OF DRAWINGS

FIG. 1 is a perspective view illustrating a configuration of a magazine attachment and detachment system in accordance with an embodiment of the present invention.

FIG. 2 is a perspective view illustrating configurations of a nutrunner and a supply device in the magazine attachment and detachment system.

FIG. 3 is a front view illustrating a configuration of a hanger in the magazine attachment and detachment system.

FIG. 4 is a perspective view illustrating a configuration of a magazine in the magazine attachment and detachment system.

FIG. 5 is a perspective view illustrating, in an enlarged manner, a configuration of a part of a retention mechanism that retains the magazine in the magazine attachment and detachment system.

FIG. 6 is a plan view illustrating a state before the magazine retained by the retention mechanism and the hanger are coupled.

FIG. 7 is a plan view illustrating a state in which the magazine retained by the retention mechanism and the hanger are coupled.

FIG. 8 is perspective views illustrating an operation in which the supply device supplies a bolt to the nutrunner.

FIG. 9 is side views and plan views illustrating an operation of attaching and detaching the magazine to and from a retention body of the retention mechanism.

FIG. 10 is a plan view illustrating a state before the magazine is attached to a retention mechanism in accordance with Variation 1 of the present embodiment.

FIG. 11 is a front view illustrating a state before the magazine is attached to the retention mechanism illustrated in FIG. 10.

FIG. 12 is plan views and front views illustrating an operation of attaching the magazine to the retention mechanism illustrated in FIG. 10.

FIG. 13 is a side view illustrating configurations of a hanger, a magazine, and a retention mechanism in accordance with Variation 2 of the present embodiment.

FIG. 14 is a cross-sectional view taken along line P-P in FIG. 13.

FIG. 15 is a cross-sectional view taken along line Q-Q in FIG. 13.

FIG. 16 is a front view illustrating configurations of the hanger, the magazine, and the retention mechanism illustrated in FIG. 13.

FIG. 17 is side views illustrating an operation of attaching and detaching the magazine illustrated in FIG. 13 to and from a retention body of the retention mechanism.

FIG. 18 is plan views illustrating transitions between a retention state in which the magazine is retained by an engagement mechanism, which engages with the magazine, of the retention body illustrated in FIG. 17 and a retention-released state in which retention of the magazine by the engagement mechanism is released.

FIG. 19 is plan views illustrating, in further detail, transitions between a retention state in which the magazine is retained by the engagement mechanism and a retention-released state in which retention of the magazine by the engagement mechanism is released.

### DESCRIPTION OF EMBODIMENTS

### Embodiment

The following description will discuss an embodiment of the present invention in detail.

### Configuration of Magazine Attachment and Detachment System

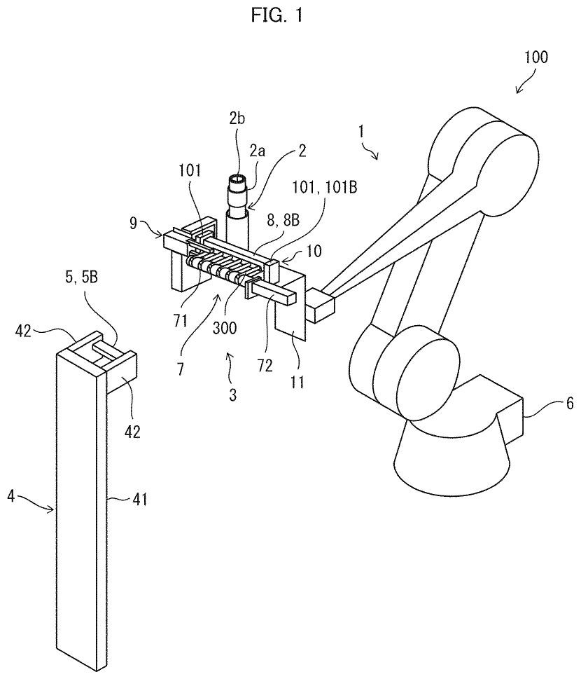

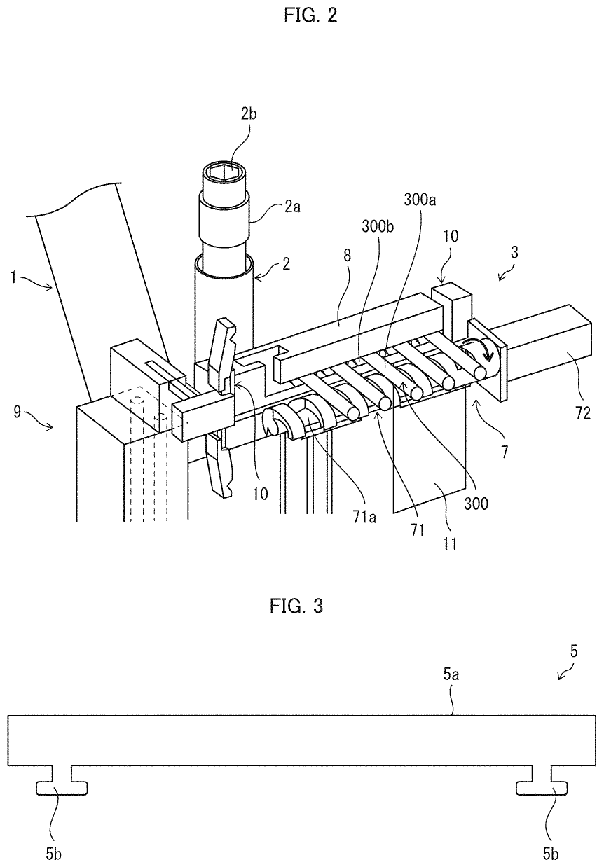

FIG. 1 is a perspective view illustrating a configuration of a magazine attachment and detachment system 100 in accordance with an embodiment of the present invention. FIG. 2 is a perspective view illustrating configurations of a nutrunner 2 and a supply device 3 in the magazine attachment and detachment system 100. FIG. 3 is a front view illustrating a configuration of a hanger 5 in the magazine attachment and detachment system 100.

As illustrated in FIG. 1, the magazine attachment and detachment system 100 includes a robot arm device 1, the nutrunner 2 (work device), the supply device 3, a support stand 4, the hanger 5 (coupling body), and a control device 6. The robot arm device 1 is provided with the nutrunner 2, the supply device 3, a magazine 8, and a retention body 101. The robot arm device 1 and the support stand 4 are, for example, fixed on a floor surface.

Note that the robot arm device 1 is not limited to a form in which the robot arm device 1 is provided in a fixed state. The robot arm device 1 may be provided, for example, on a self-propelled vehicle so as to be movable. Further, the magazine attachment and detachment system 100 may include, instead of the support stand 4, a robot including the hanger 5.

The nutrunner 2 is a device that performs an operation of tightening a bolt 300 (article supplied) using the bolt 300. The magazine 8 is a structure that accommodates a part of the bolt 300 such that the part of the bolt 300 is loaded. The supply device 3 is a device that supplies the bolt 300 from the magazine 8 to the nutrunner 2. The retention body 101 is a structure that retains the magazine 8, and is provided in a retention mechanism 10 included in the supply device 3, as will be described later. The magazine attachment and detachment system 100 is a system in which the magazine 8 is attached to and detached from the retention body 101 by movement of the robot arm device 1. Further, a magazine attachment and detachment method realized by the magazine attachment and detachment system 100 is a method for attaching and detaching the magazine 8 to and from the retention body 101 by the robot arm device 1.

The robot arm device 1 is a vertical articulated robot having a plurality of joints that are rotatable, and is capable of complex movements. A support frame 11 is provided at a distal end of the robot arm device 1. The support frame 11 is provided with the nutrunner 2 and the supply device 3. The robot arm device 1 is installed, for example, on a floor surface.

The nutrunner 2 is a bolt fastening machine that fastens the bolt 300. The nutrunner 2 can communicate with the control device 6 and operates upon receiving control instructions from the control device 6. Note that the nutrunner 2 may have, for example, a controller (not illustrated) provided on the support frame 11 as a dedicated control device, and may communicate with the control device 6 via the controller. The nutrunner 2 includes a main body part 2a and a socket 2b.

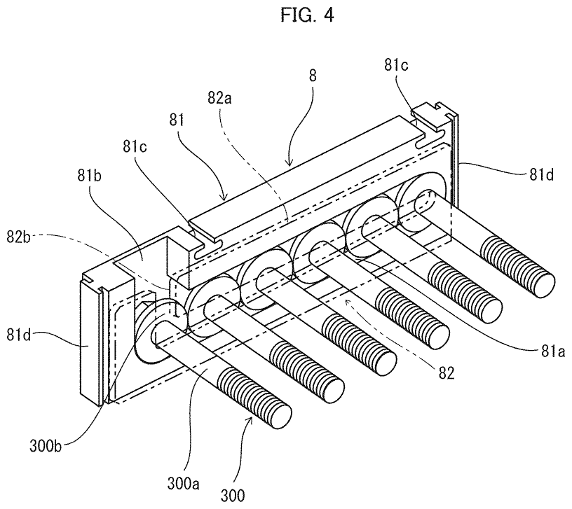

The main body part 2a is formed in a multi-stage cylindrical shape. The main body part 2a is disposed on an upper surface of the support frame 11 and is provided, for example, so as to stand upright perpendicularly to the upper surface of the support frame 11. The socket 2b is provided on a distal end surface of the main body part 2a and has a recess whose shape allows a head 300b (see FIG. 4) of the bolt 300 to be fitted. The bolt 300 is a flanged bolt, and the head 300b includes a hexagonal part of hexagonal shape and a flange part. The flange part is provided at a base portion of a shank 300a of the bolt 300, and is a collar portion formed in a circular shape and having a diameter larger than that of the shank 300a.

The supply device 3 includes a feed mechanism 7, the magazine 8, a supply mechanism 9, and the retention mechanism 10.

The feed mechanism 7 is a mechanism that feeds the bolt 300 in a linear direction. The feed mechanism 7 includes a shaft 71 and a motor 72. As illustrated in FIG. 2, a helical groove 71a is formed in an outer circumferential surface of the shaft 71. The motor 72 drives the shaft 71 such that the shaft 71 rotates about a central axis thereof.

On the helical groove 71a of the feed mechanism 7, shanks 300a of a plurality of bolts 300 are disposed such that a longitudinal direction of each of the shanks 300a is perpendicular to the central axis of the shaft 71 and that the shanks 300a are arranged in a straight line along the central axis. The shaft 71 of the feed mechanism 7 rotates so that the position of the helical groove 71a on which the shanks 300a are disposed moves toward a distal end of the shaft 71. By this, the feed mechanism 7 moves the shanks 300a toward the distal end of the shaft 71.

The feed mechanism 7 is disposed on a side opposite to a side on which the nutrunner 2 is disposed, with the magazine 8 interposed therebetween. Specifically, the feed mechanism 7 is disposed such that a distal end part of the shaft 71 is aligned with the nutrunner 2 with a discharge side of the magazine 8, from which the bolts 300 are discharged, interposed therebetween.

The magazine 8 is provided so as to be attachable to and detachable from the supply device 3. As described above, the magazine 8 accommodates a part of each of the bolts 300, and also has a role of assisting feeding of the bolts 300 by the feed mechanism 7. The magazine 8 retains the heads 300b of the bolts 300 and portions of the shanks 300a which portions are in the vicinity of the heads 300b. Most of each shank 300a is exposed from the magazine 8. The structure of the magazine 8 will be described in detail later.

The supply mechanism 9 is a mechanism that grips each bolt 300 fed by the feed mechanism 7 and moves the bolt 300 so as to supply the bolt 300 to the nutrunner 2. Specifically, the supply mechanism 9 grips the bolt 300 with claws, and changes the orientation of the bolt 300, which is oriented in a horizontal direction in a fed state, such that the head 300b is positioned on a lower side and the shank 300a is oriented in a vertical direction. Further, the supply mechanism 9 moves the bolt 300 to a position above the socket 2b of the nutrunner 2 and disposes the head 300b in the socket 2b.

Note that the configuration of the supply mechanism 9 is not limited to the above-described configuration, as long as the supply mechanism 9 can supply the bolt 300 fed by the feed mechanism 7 to the socket 2b of the nutrunner 2.

The retention mechanism 10 is a mechanism that includes the above-described retention body 101 and detachably retains the magazine 8. The structure of the retention mechanism 10 will be described in detail later.

The support stand 4 is disposed on a floor surface at a position spaced apart from a position where the robot arm device 1 is fixed, by a predetermined distance. The support stand 4 includes a main body part 41 and retention parts 42.

The main body part 41 is a plate-like member formed to extend vertically relative to the floor surface. The retention parts 42 are a pair of retention parts provided at a distance from each other at an upper end of the main body part 41, on a surface facing the robot arm device 1. The retention parts 42 are formed to extend toward the robot arm device 1. The retention parts 42 retain the hanger 5 so as to sandwich the hanger 5 at both ends of the hanger 5. Thus, the hanger 5 is fixed at a certain position.

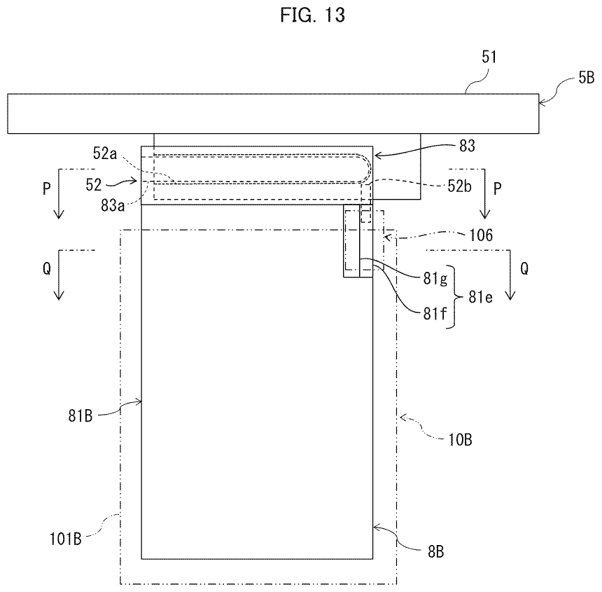

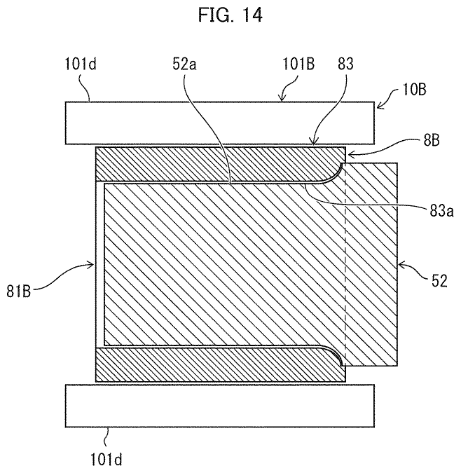

Note that the structure for fixing the hanger 5 is not limited to the support stand 4 and may be any structure as long as the hanger 5 can be fixed at a certain position. A fixing structure for fixing a hanger 5B (see FIG. 13 etc.) described later is also configured similarly to the structure for fixing the hanger 5.

The hanger 5 has a structure for coupling to the magazine 8 and, as described above, is fixed at a predetermined position by the support stand 4. The hanger 5 is provided for attaching and detaching the magazine 8 to and from the retention body 101 of the supply device 3.

As illustrated in FIG. 3, the hanger 5 includes a hanger main body 5a and two projections 5b. The hanger main body 5a has an elongated quadrangular prism shape. The projections 5b are provided near respective end parts of the hanger main body 5a, on a coupling surface which is one of surfaces of the hanger main body 5a along a longitudinal direction of the hanger 5 and which is to be coupled to the magazine 8. The projections 5b are each formed over an entire width direction of the hanger main body 5a. Each projection 5b includes a raised part that rises vertically from the coupling surface and a wide part provided at an end of the raised part and having a width larger than a width of the raised part.

Note that the hanger main body 5a may have a shape other than the quadrangular prism shape. Further, the shape and the number of the projections 5b are not limited to the above shape and number. Further, each of the projections 5b need not be formed over the entire width direction of the hanger main body 5a and may be formed over a part of the width direction of the hanger main body 5a.

The control device 6 controls operations of the robot arm device 1 and the supply device 3. The control device 6 also controls an operation of the robot arm device 1 for attaching and detaching the magazine 8 to and from the supply device 3 (the retention body 101). The operation of attaching and detaching the magazine 8 by the robot arm device 1 will be described in detail later.

Note that although the nutrunner 2 described above is a bolt fastening machine, it is possible, in the present embodiment, to use as the work device a device having a work function other than that of the nutrunner 2. Further, although, in the supply device 3, the feed mechanism 7 is a mechanism that feeds the bolts 300 by movement of the helical groove 71a, the feed mechanism 7 may be a mechanism having a structure other than such a structure. Further, the feed mechanism 7 may be a mechanism that feeds an article to be supplied other than the bolts 300 and that has a structure adapted to the article.

### Configurations of Magazine and Retention Mechanism

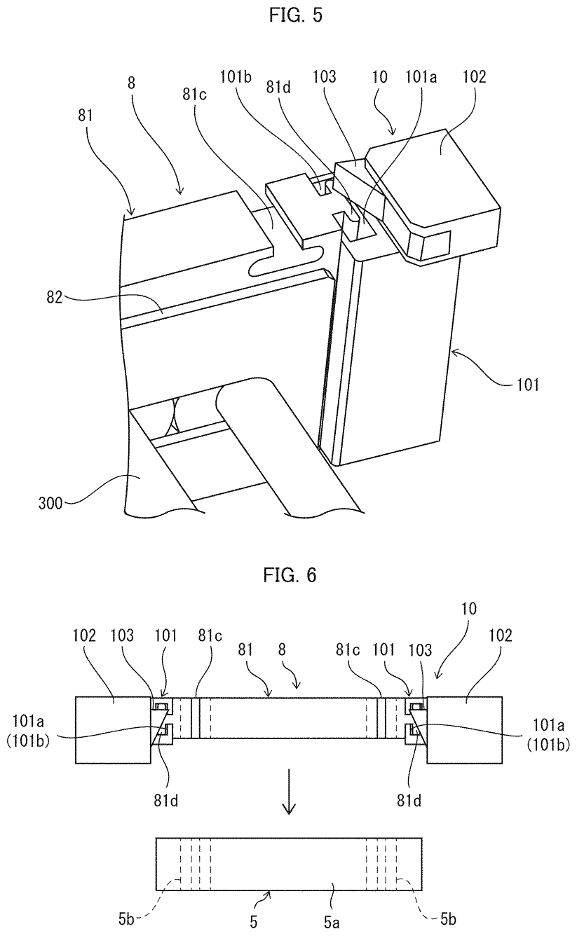

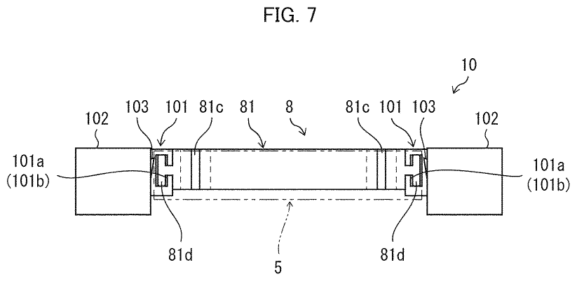

FIG. 4 is a perspective view illustrating a configuration of the magazine 8. FIG. 5 is a perspective view illustrating, in an enlarged manner, a configuration of a part of the retention mechanism 10 that retains the magazine 8. FIG. 6 is a plan view illustrating a state before the magazine 8 retained by the retention mechanism 10 and the hanger 5 are coupled. FIG. 7 is a plan view illustrating a state in which the magazine 8 retained by the retention mechanism 10 and the hanger 5 are coupled.

As illustrated in FIG. 4, the magazine 8 includes a main body part 81 and a cover 82.

The main body part 81 is a plate-like member forming a rectangular shape and having a predetermined thickness. The main body part 81 includes a retention groove 81a, a take-out opening 81b, fitting grooves 81c, and protruding ridges 81d. The main body part 81 has four surfaces formed on outer peripheries of two opposed largest surfaces of the main body part 81, and one of two longer-side surfaces among the four surfaces serves as a coupling surface to be coupled to the hanger 5 described above. Further, among the four surfaces, two shorter-side surfaces serve as retention surfaces to be retained by the retention mechanism 10.

Note that the coupling surface of the main body part 81 is not limited to the above surface; for example, the coupling surface may be one of the largest surfaces, or may be one of the two shorter-side surfaces among the four surfaces formed on the outer peripheries of the largest surfaces. Note that the shape of the main body part 81 is not limited to a rectangle and may be another shape such as a square. The coupling surface of the main body part 81 is appropriately set depending on the shape of the main body part 81.

The retention groove 81a is formed to extend in a longitudinal direction of the main body part 81 so as to be open to one of the opposed largest surfaces, and be bent, at one end side of the retention groove 81a, toward an upper surface side of the coupling surface. The retention groove 81a has a width slightly larger than the diameter of the flange part of each of the heads 300b of the bolts 300 so as to stably guide the heads 300b. The take-out opening 81b is a portion where the retention groove 81a opens to the coupling surface, and is provided to allow the bolts 300 to be taken out from the magazine 8. The take-out opening 81b is formed on the side of one end part of the coupling surface.

The fitting grooves 81c are grooves that fit with the projections 5b of the hanger 5. The fitting grooves 81c are formed in the coupling surface of the main body part 81, near an end part opposite to the end part where the take-out opening 81b is provided, and near the take-out opening 81b, respectively. Each fitting groove 81c is formed over an entire width direction of the coupling surface. Each fitting groove 81c is formed with a predetermined depth from the coupling surface and includes: a constricted part that fits with the raised part of a projection 5b of the hanger 5; and an expanded part that is provided at an end of the constricted part so as to expand further from the constricted part and fit with a wide part of the hanger 5.

The protruding ridges 81d are provided over the entire retention surfaces of the main body part 81. Each protruding ridge 81d includes a raised part that rises from the retention surface and a wide part having a width larger than that of the raised part.

Note that the protruding ridges 81d need not be provided over the entire retention surfaces of the main body part 81 and may be provided only, for example, on upper portions of the retention surfaces.

The cover 82 covers a part of the retention groove 81a. The cover 82 includes a cover main body 82a and a slit 82b.

The cover main body 82a is a plate-like member and is attached to a side of the main body part 81 on which side the shanks 300a of the bolts 300 are disposed. The slit 82b is provided in the cover main body 82a so as to extend along the retention groove 81a. A horizontally extending portion of the slit 82b is formed such that a height from a bottom of the retention groove 81a that is contacted by the head 300b (the flange part) of each bolt 300 is substantially equal to a width of the flange part. The slit 82b has a width slightly larger than that of the shank 300a of each bolt 300.

As illustrated in FIGS. 5 and 6, the retention mechanism 10 is a mechanism that retains the magazine 8 at both side ends of the magazine 8. The retention mechanism 10 includes the retention body 101, a rotation support part 102, and a projecting and retracting lock 103 (attachment fixing member).

The retention body 101 is two quadrangular prism-shaped members provided adjacent to the above-described retention surfaces at both side ends of the magazine 8, respectively. The retention body 101 includes fitting grooves 101a. The fitting grooves 101a are provided over the entire lengths of counter surfaces of the retention body 101, which counter surfaces face the retention surfaces of the magazine 8, so as to fit with the protruding ridges 81d of the magazine 8. Upper end portions of the fitting grooves 101a each serve as an entrance/exit region 101b of the retention body 101 through which the magazine 8 enters and exits the retention body 101.

Note that the fitting grooves 101a need not be provided over the entire lengths of the counter surfaces of the retention body 101, as long as the fitting grooves 101a are provided in accordance with the areas in which the protruding ridges 81d are provided. For example, in a case where the protruding ridges 81d are provided only on upper portions of the retention surfaces of the main body part 81 as described above, the fitting grooves 101a need only be provided only in upper portions of the counter surfaces of the retention body 101.

The rotation support part 102 rotatably supports the projecting and retracting lock 103 so as to allow the projecting and retracting lock 103 to move between a fixation position and a non-fixation position. The rotation support part 102 is disposed on an upper end surface of the retention body 101. The rotation support part 102 urges the projecting and retracting lock 103 by a spring such that the projecting and retracting lock 103 is at the fixation position.

As illustrated in FIG. 6, the fixation position is a position at which the projecting and retracting lock 103 fixes attachment of the magazine 8 to the retention body 101 by being located in at least a part of the entrance/exit region 101b. As illustrated in FIG. 7, the non-fixation position is a position at which the projecting and retracting lock 103 is not located in the entrance/exit region 101b.

As illustrated in FIG. 6, in a state where the magazine 8 is not coupled to the hanger 5 and the projecting and retracting lock 103 is at the fixation position, a triangular-shaped portion of the projecting and retracting lock 103 projects from the rotation support part 102. In contrast, when the magazine 8 is coupled to the hanger 5 as illustrated in FIG. 7 by being moved together with the retention body 101 in a direction indicated by an arrow, the projecting and retracting lock 103 moves to the non-fixation position. In this state, a corner portion of the hanger main body 5a of the hanger 5 abuts against an inclined surface of the projecting and retracting lock 103, so that the projecting and retracting lock 103 is pushed into the rotation support part 102. In this manner, the projecting and retracting lock 103 operates so as to project from and retract into the rotation support part 102.

### Bolt Supply Operation

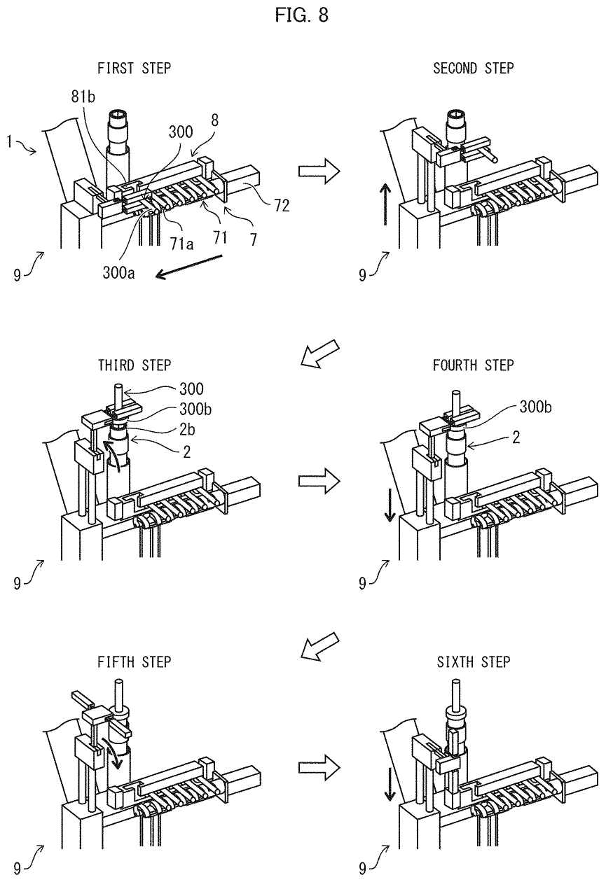

The following description will discuss an operation of supplying the bolts 300 by the supply device 3 configured as described above. FIG. 8 is perspective views illustrating an operation in which the supply device 3 supplies a bolt to the nutrunner 2.

As illustrated in FIG. 8, first, in a first step, the shaft 71 of the feed mechanism 7 rotates to feed the shanks 300a of the bolts 300 disposed in the helical groove 71a of the shaft 71 in a direction indicated by an arrow. When a bolt 300 thereby reaches the take-out opening 81b of the magazine 8, the supply mechanism 9 grips the shank 300a of the bolt 300.

In a second step, the supply mechanism 9 moves the gripped bolt 300 along the nutrunner 2.

In a third step, the supply mechanism 9 rotates the bolt 300 in an arrow direction to move the head 300b of the bolt 300 to a position facing the socket 2b of the nutrunner 2.

In a fourth step, the supply mechanism 9 slightly lowers the bolt 300 to thereby move the bolt 300 closer to the nutrunner 2. As a result, the head 300b (hexagonal part) of the bolt 300 fits into the socket 2b. In this manner, supply of the bolt 300 to the nutrunner 2 is completed.

Note that, in the fourth step, fitting of the bolt 300 gripped by the supply mechanism 9 into the socket 2b may be detected on the basis of an increase in a torque value of the nutrunner 2 rotating at a low speed.

In a fifth step, the supply mechanism 9 separates from the bolt 300. Further, in a sixth step, the supply mechanism 9 moves a portion for gripping the bolt 300 such that the portion changes a posture thereof and returns to a standby position.

### Magazine Attachment and Detachment Operation

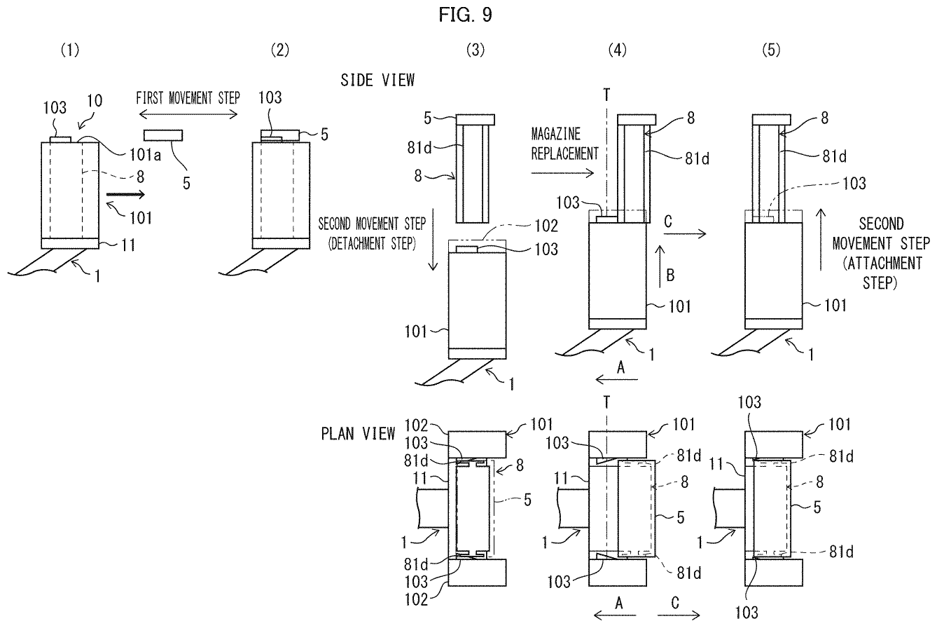

The following describes an operation of attaching and detaching the magazine 8 of the magazine attachment and detachment system 100. FIG. 9 is side views and plan views illustrating an operation of attaching and detaching the magazine 8 to and from the retention body 101 of the retention mechanism 10.

As illustrated in FIG. 9, the robot arm device 1 performs an operation of attaching the magazine 8 to and from the retention body 101.

### (1) Non-Coupling Position

The magazine 8 is attached to the retention body 101, and the attached state is fixed by the projecting and retracting lock 103, so that the magazine 8 is retained by the retention body 101. In this state, the retention body 101 is at a non-coupling position away from the hanger 5, and the magazine 8 is not coupled to the hanger 5.

### (2) Coupling Position

When the magazine 8 reaches a coupling position and is coupled to the hanger 5, the projecting and retracting lock 103 moves from the fixation position to the non-fixation position, and the state in which the attachment of the magazine 8 is fixed by the projecting and retracting lock 103 is released.

### (3) Detachment Position

When the retention body 101 descends from the coupling position, the retention body 101 reaches a detachment position at which the magazine 8 has been detached. In this state, pushing-in of the projecting and retracting lock 103 by the hanger 5 is released, so that the projecting and retracting lock 103 returns to the fixation position by an urging force of the rotation support part 102.

### (4) Release Preparation Position

When a magazine 8 replacing the above magazine 8 is coupled to the hanger 5, the retention body 101 moves from the detachment position in an A direction, which is a direction slightly retreating relative to the magazine 8, as a preparation stage before moving to an attachable position (described later). This is due to the following reason. In a state where the retention body 101 is at the detachment position, the projecting and retracting lock 103 is at the fixation position. As such, when the retention body 101 is raised as it is, a lower end of each protruding ridge 81d of the magazine 8 abuts against the projecting and retracting lock 103. This prevents the magazine 8 from being attached to the retention body 101. For this reason, the retention body 101 is moved to a release preparation position at which the lower end of each protruding ridge 81d can push in the projecting and retracting lock 103 as described later. The release preparation position is such a position that portions of the pair of projecting and retracting locks 103 which portions first come into contact with the protruding ridges 81d when the magazine 8 is attached to the retention body 101 are spaced apart from the protruding ridges 81d in the A direction (the example illustrated in FIG. 9).

Further, the retention body 101 moves in a B direction (upward direction) such that at least the lower ends of the protruding ridges 81d of the magazine 8 are positioned at a height between an upper end of each projecting and retracting lock 103 and an upper end of the retention body 101. As a result, the retention body 101 reaches the release preparation position where the lower ends of the protruding ridges 81d can abut against the projecting and retracting locks 103, which are at the fixation position, and release the fixation.

Note that the retention body 101 need not move in the A direction as long as the retention body 101 is at the release preparation position in a relative positional relationship with the magazine 8; for example, the hanger 5B, which is fixed in principle, may be moved in a direction opposite to the A direction.

### (5) Attachable Position

The retention body 101 moves from the release preparation position in a C direction opposite to the A direction. This causes the lower ends of the protruding ridges 81d to push the projecting and retracting locks 103 at the fixation position into the rotation support part 102 so as to move the projecting and retracting locks 103 to the non-fixation position. Thus, the retention body 101 reaches an attachable position at which the magazine 8 can be attached.

### First Movement Step

The control device 6 controls movement of the robot arm device 1 and moves the robot arm device 1 relative to the hanger 5, thereby moving the retention body 101 on which the magazine 8 is attached between the coupling position and the non-coupling position. Through this, when the retention body 101 before replacement of the magazine 8 is moved from the non-coupling position to the coupling position, the magazine 8 becomes detachable from the retention body 101 (coupling step). Further, as described later, when the retention body 101 after replacement of the magazine 8 is moved from the coupling position to the non-coupling position, coupling of the magazine 8 by the hanger 5 is released (coupling release step).

### Second Movement Step

The control device 6 controls movement of the robot arm device 1 and moves the robot arm device 1 relative to the hanger 5, thereby moving the retention body 101 between the coupling position and the detachment position. Through this, when the retention body 101 is moved from the coupling position to the detachment position, the magazine 8 is detached from the retention body 101 (detachment step). Further, when the retention body 101 is moved from the detachment position to the attachable position via the release preparation position and further moved upward until reaching the coupling position, the magazine 8 is attached to the retention body 101 (attachment step).

In the second movement step, a remote direction, in which the retention body 101 moves away from the magazine 8, and a proximity direction, in which the retention body 101 approaches the magazine 8, are up-down directions and thus different from a coupling direction (horizontal direction) in which the magazine 8 is coupled to the hanger 5 in the first movement step. As such, in movement from the coupling position to the detachment position, the robot arm device 1 moves the retention body 101 in the remote direction, and in movement from the detachment position to the coupling position, the robot arm device 1 moves the retention body 101 in the proximity direction.

### Effects of Embodiment

As described above, the magazine attachment and detachment system 100 includes the robot arm device 1, the nutrunner 2, the supply device 3, the hanger 5, the control device 6, and the magazine 8. The control device 6 controls movement of the robot arm device 1 relative to the hanger 5 so as to move the retention body 101 between the coupling position and the non-coupling position and so as to move the retention body 101 between the coupling position and the detachment position.

The robot arm device 1 functions to move the nutrunner 2 to a required position for bolt fastening work and also includes the supply device 3. With use of such a robot arm device 1, the magazine 8 is moved to the coupling position so that the magazine 8 is coupled to the hanger 5, and the magazine 8 is moved to the non-coupling position so that the magazine 8 is no longer coupled to the hanger 5. Further, the retention body 101 is moved from the coupling position to the detachment position so that the magazine 8 is detached from the retention body 101, and the retention body 101 is moved from the detachment position to the coupling position so that the magazine 8 is attached to the retention body 101.

In this manner, attachment and detachment of the magazine 8 to and from the retention body 101 is performed by movement of the robot arm device 1. Therefore, it is unnecessary to separately provide driving means for attaching and detaching the magazine 8. Accordingly, complication of the device configuration can be avoided.

Further, in the coupling step, the retention body 101 is moved from the non-coupling position to the coupling position, so that the magazine 8 retained by the retention body 101 is coupled to the hanger 5. From this state, in the detachment step, the retention body 101 is moved to the detachment position, so that the magazine 8 is detached from the retention body 101. In the state where the retention body 101 is at the detachment position, the magazine 8 coupled to the hanger 5 is replaced. Then, in the attachment step, the retention body 101 is moved to the coupling position via the release preparation position and the attachable position, so that the magazine 8 is attached to the retention body 101. Further, in the coupling release step, the retention body 101 is moved to the non-coupling position, so that coupling between the magazine 8 and the hanger 5 is released. In this manner, the magazine 8 can be replaced.

Further, since the remote direction and the proximity direction in the second movement step differ from the coupling direction, the range of movement of the retention body 101 can be narrowed compared with a case where the remote direction and the proximity direction are the same as the coupling direction. For example, in a case where the remote direction, the proximity direction, and the coupling direction are each a horizontal direction, the retention body moves widely in the horizontal direction. In contrast, in a case where the coupling direction is a horizontal direction whereas the remote direction is a downward direction and the proximity direction is an upward direction, the range of movement of the retention body in the horizontal direction can be narrowed.

Further, in a state where the retention body 101 is at the non-coupling position, attachment of the magazine 8 to the retention body 101 is fixed by the projecting and retracting lock 103. Thus, regardless of an orientation in which the robot arm device 1 moves, detachment of the magazine 8 from the retention body 101 can be prevented. Further, in states where the retention body 101 is at the coupling position and the attachable position, the entrance/exit region 101b of the retention body 101 is not closed by the projecting and retracting lock 103. This enables the magazine 8 to be detachable from the retention body 101 at the coupling position, and to be attachable to the retention body 101 at the attachable position.

### Variation 1

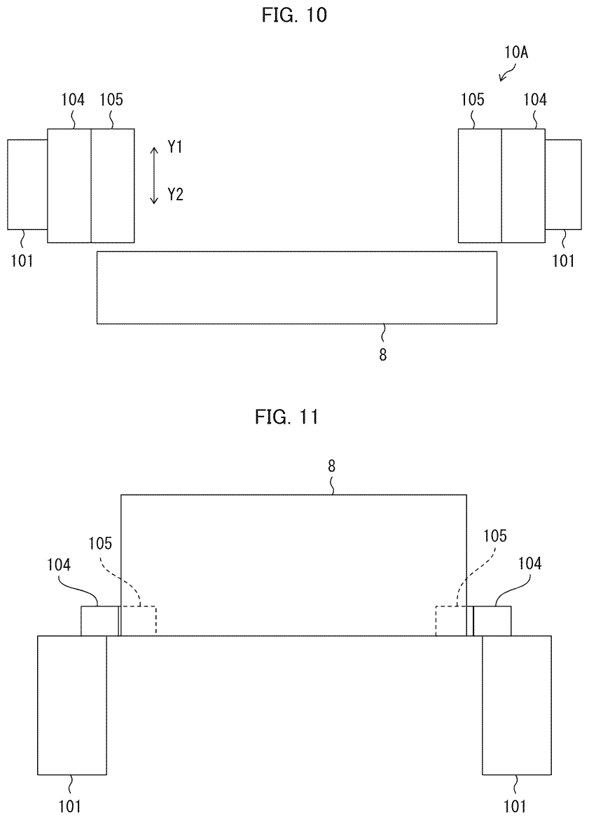

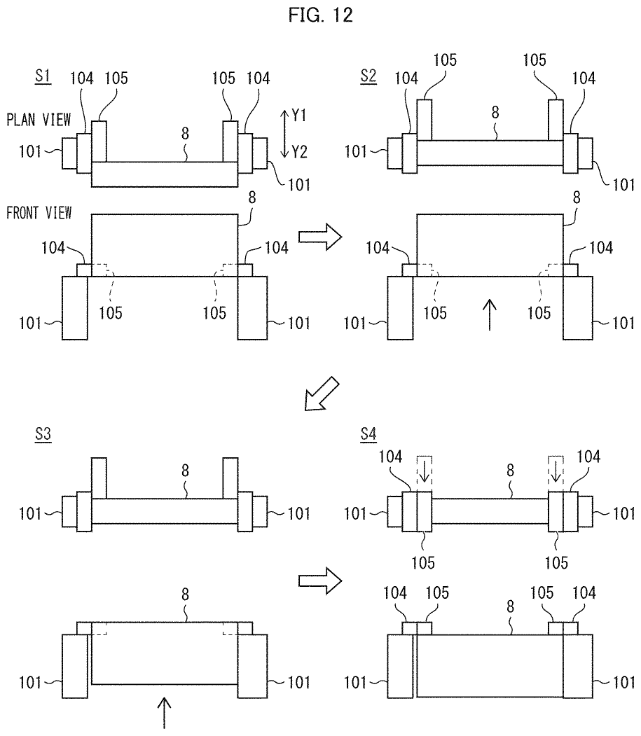

The following will describe Variation 1 of the present embodiment. FIG. 10 is a plan view illustrating a state before a magazine 8 is attached to a retention mechanism 10A in accordance with Variation 1 of the present embodiment. FIG. 11 is a front view illustrating a state before the magazine 8 is attached to the retention mechanism 10A. FIG. 12 is plan views and front views illustrating an operation of attaching the magazine 8 to the retention mechanism 10A.

As illustrated in FIGS. 10 and 11, in the present variation, a supply device 3 of a magazine attachment and detachment system 100 includes a retention mechanism 10A instead of the retention mechanism 10. The retention mechanism 10A, similarly to the retention mechanism 10, is a mechanism that retains a magazine 8 at both side ends of the magazine 8. The retention mechanism 10A includes a retention body 101, a slide support part 104, and a slide lock 105 (attachment fixing member).

The slide support part 104 supports the slide lock 105 so as to allow the slide lock 105 to move slidably in a Y1 direction and a Y2 direction. The slide support part 104 is disposed on an upper end surface of the retention body 101. The slide support part 104 urges the slide lock 105 in the Y2 direction by a spring. Thus, the slide lock 105 is at a fixation position. The slide lock 105 is provided so as to be movable between the fixation position and a non-fixation position by being supported by the slide support part 104. At the fixation position, the slide lock 105 is located in at least a part of an entrance/exit region 101b described above. At the non-fixation position, the slide lock 105 is not located in the entrance/exit region 101b.

As illustrated in FIG. 12, moving the retention body 101 in the Y2 direction causes a lower end part of the magazine 8 to abut against a surface of the slide lock 105 which surface faces the magazine 8. Then, as the retention body 101 advances in the Y2 direction, the slide lock 105 moves in the Y1 direction (step S1). Subsequently, when the magazine 8 reaches an attachable position, the slide lock 105 moves to the non-fixation position (step S2).

By moving the retention body 101 upward from the state in step S2, the magazine 8 becomes attached to the retention body 101 (step S3). During this period, the slide lock 105 continues to abut against the magazine 8, so that the slide lock 105 remains at the non-fixation position.

When the magazine 8 is completely attached to the retention body 101, the slide lock 105 no longer abuts against the magazine 8, so that the slide lock 105 moves in the Y2 direction by an urging force of the slide support part 104 and returns to the fixation position (step S4). In this manner, the magazine 8 is attached to the retention body 101.

In the above example, movement of the slide lock 105 at the time of attaching the magazine 8 to the retention body 101 has been described. In contrast, in detachment of the magazine 8 from the retention body 101, when the magazine 8 is coupled to the hanger 5, the slide lock 105 is pushed in the Y1 direction in a state of abutting against the hanger 5, and moves to the non-fixation position. Thus, in a state where the magazine 8 is coupled to the hanger 5, a state in which attachment is fixed by the slide lock 105 is released, and the magazine 8 becomes detachable from the retention body 101.

The slide lock 105 of the present variation, similarly to the projecting and retracting lock 103, can prevent detachment of the magazine 8 from the retention body 101 regardless of an orientation in which a robot arm device 1 moves. Further, the slide lock 105 enables the magazine 8 to be detachable from the retention body 101 at a coupling position, and to be attachable to the retention body 101 at an attachable position.

### Variation 2

### Configurations of Hanger, Magazine, and Retention Mechanism

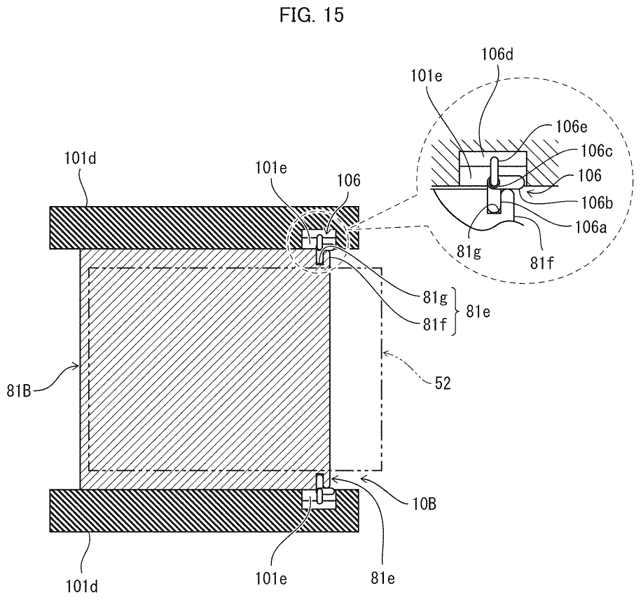

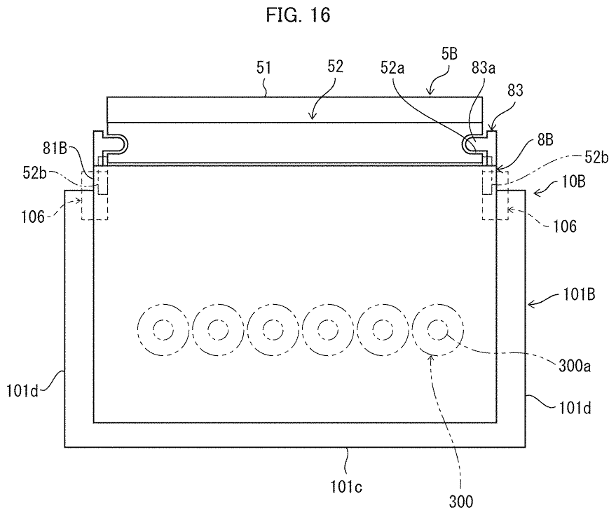

The following will describe Variation 2 of the present embodiment. FIG. 13 is a side view illustrating configurations of a hanger, a magazine, and a retention mechanism in accordance with Variation 2 of the present embodiment. FIG. 14 is a cross-sectional view taken along line P-P in FIG. 13. FIG. 15 is a cross-sectional view taken along line Q-Q in FIG. 13. FIG. 16 is a front view illustrating configurations of the hanger, the magazine, and the retention mechanism illustrated in FIG. 13.

As illustrated in FIGS. 13 to 16, in the present variation, a supply device 3 in a magazine attachment and detachment system 100 includes a hanger 5B, a magazine 8B, and a retention mechanism 10B instead of the hanger 5 (coupling body), the magazine 8, and the retention mechanism 10.

The hanger 5B has a structure for coupling to the magazine 8 and, similarly to the hanger 5, is fixed at a predetermined position by a support stand 4. The hanger 5B is provided for attaching and detaching the magazine 8B to and from a retention body 101B of the retention mechanism 10B. The hanger 5B includes a support plate 51 and a coupling main body 52.

The support plate 51 is a member that supports the coupling main body 52 on a lower surface of the support plate 51 and is fixed by the support stand 4. The coupling main body 52 is a plate-like member having a predetermined thickness, and long grooves 52a extending in a horizontal direction are formed in both side surfaces of the coupling main body 52. Each long groove 52a is formed such that one end of the long groove 52a reaches an end part (introduction end part) of the coupling main body 52 on a side from which the magazine 8B is introduced at the time of coupling. Each long groove 52a is formed such that the other end of the long groove 52a does not reach an end part of the coupling main body 52 opposite to the introduction end part.

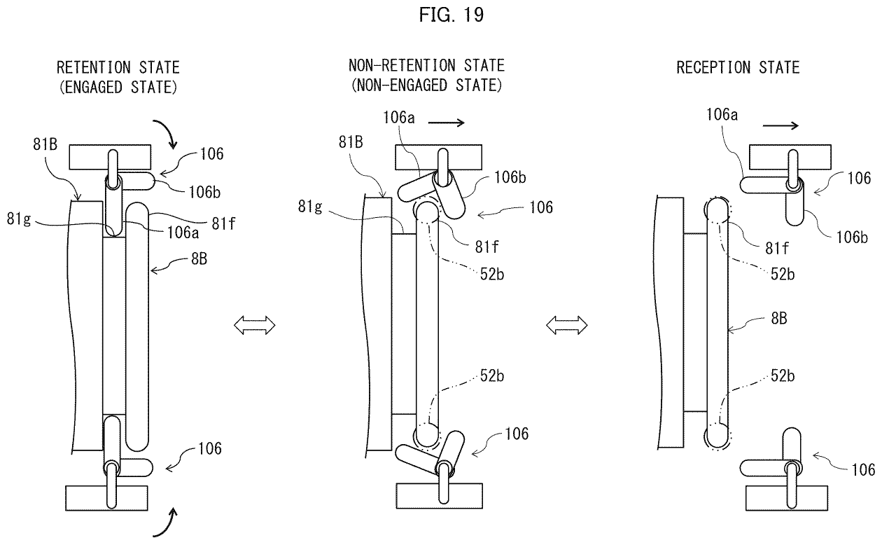

The coupling main body 52 includes a pair of projections 52b. The pair of projections 52b are, for example, in a cylindrical shape. The pair of projections 52b are provided near end parts of the long grooves 52a in both side surfaces of the coupling main body 52, the end parts being on a side opposite to the side of the introduction end part, such that the projections 52b are oriented in an up-down direction and lower parts of the projections 52b protrude downward from a lower end surface of the coupling main body 52. Further, the pair of projections 52b are disposed such that, in a state in which the magazine 8B is coupled to the hanger 5B, the pair of projections 52b are located substantially above both end parts of abutment parts 81f (described later) of the magazine 8B (see FIGS. 13 and 19).

Similarly to the magazine 8, the magazine 8B is provided so as to be attachable and detachable from the supply device 3, and not only accommodates a part of each bolt 300 but also has a role of assisting feeding of bolts 300 by the feed mechanism 7. The magazine 8B includes a main body part 81B, a cover 82, and coupling parts 83. For convenience, illustration of the cover 82 is omitted in FIGS. 13 and 16.

Although not illustrated, the main body part 81B includes a retention groove 81a, a take-out opening 81b, and fitting grooves 81c similarly to the main body part 81 of the magazine 8. The main body part 81B does not include the protruding ridges 81d of the main body part 81, but includes engagement part 81e as a structure to be retained by the retention mechanism 10B.

The engagement part 81e has a structure for engaging with an engagement mechanism 106 (described later) included in the retention mechanism 10B. The engagement part 81e can be provided at any height position of the main body part 81B at which the engagement part 81e engages with the engagement mechanism 106. The engagement part 81e includes the abutment parts 81f and constricted parts 81g.

The abutment parts 81f are provided at end parts of the main body part 81B on a side where the magazine 8B faces the hanger 5B at the time of being coupled to the hanger 5B. Each abutment part 81f has a predetermined thickness and a predetermined width in the up-down direction so as to abut against engagement pieces 106a and 106b (described later) of the engagement mechanism 106. An end part of the abutment part 81f is preferably formed to have a curved surface shape so that the engagement pieces 106a and 106b can smoothly displace between engagement and disengagement of the abutment part 81f with the engagement pieces 106a and 106b.

The constricted parts 81g are provided adjacent to the abutment parts 81f. Each constricted part 81g is formed to have a depth into which the engagement piece 106a fits and a width that enables the engagement piece 106a to enter into the constricted part 81g while rotating as described later.

The coupling parts 83 are provided in a pair at both side parts of an upper end surface of the main body part 81B. The coupling parts 83 are each a plate-like portion provided over an entire thickness direction of the main body part 81B. The coupling parts 83 include protrusion parts 83a on surfaces facing each other. Each protrusion part 83a has a shape that fits into a long groove 52a of the hanger 5B, and is formed by, for example, a protruding ridge.

Note that each coupling part 83 need not be provided over the entire thickness direction of the main body part 81B and may be provided over a part of the thickness direction of the main body part 81B. Further, each protrusion part 83a is not limited to the protruding ridge, as long as the protrusion part 83a has a structure that can be stably coupled to the long groove 52a. For example, each protrusion part 83a may be a plurality of projections disposed so as to be arranged in a straight line at intervals.

The retention mechanism 10B is a mechanism that retains the magazine 8B at both side ends of the magazine 8B. The retention mechanism 10B includes the retention body 101B and the engagement mechanism 106.

The retention body 101B includes a bottom part 101c and side parts 101d. The bottom part 101c is a portion that supports the magazine 8B. The side parts 101d are a pair of wall-shaped portions provided to rise from both side parts of the bottom part 101c and retain the main body part 81B of the magazine 8B from both sides. The side parts 101d has recesses 101e. The recesses 101e are provided near end parts of the side parts 101d on the same side where the magazine 8B faces the hanger 5B at the time of being coupled to the hanger 5B, and are located at a given height on faces of the side parts 101d which faces face each other.

The engagement mechanism 106 is a mechanism that engages with the engagement part 81e of the main body part 81B. The engagement mechanism 106 is provided in the recesses 101e in the retention body 101B. Further, the engagement mechanism 106 is positioned such that an upper part of the engagement mechanism 106 protrudes from an upper end of the retention body 101B and, in a state where the magazine 8B is coupled to the hanger 5B, abuts against the above-described lower parts of the projections 52b. The engagement mechanism 106 includes the engagement pieces 106a and 106b (attachment fixing member), a support shaft 106c, a support base 106d, and a support member 106e.

The engagement pieces 106a and 106b are plate-like members and are coupled to each other so as to form a right angle or an angle close to a right angle therebetween. The engagement pieces 106a and 106b are provided so as to be movable between a fixation position for fixing attachment of the magazine 8B to the retention body 101B and a non-fixation position for not fixing attachment of the magazine 8B to the retention body 101B.

The support shaft 106c is a shaft that rotatably supports the engagement pieces 106a and 106b at a position at which the engagement pieces 106a and 106b are coupled to each other. A lower end part of the support shaft 106c is supported near an opening portion of each recess 101e. The support member 106e is a member for supporting an upper end part of the support shaft 106c on the support base 106d provided in a deep portion of each recess 101e.

The engagement mechanism 106 configured as described above rotates when a force of not less than a certain level is applied to the engagement pieces 106a and 106b. As described later, the force of not less than a certain level is a force received by the engagement pieces 106a and 106b from the main body part 81B of the magazine 8B when the magazine 8B coupled to the hanger 5B moves relative to the retention mechanism 10B. Further, the force of not less than a certain level may be a force greater than a load attributable to a weight of the magazine 8B loaded with the bolts 300. This, for example, prevents the engagement pieces 106a and 106b from being rotated even if the engagement pieces 106a and 106b receive the load of the magazine 8B due to a change in the posture of the robot arm device 1 to an orientation in which the magazine 8B falls. Thus, it is possible to maintain a state in which the magazine 8B is retained.

### Magazine Attachment and Detachment Operation

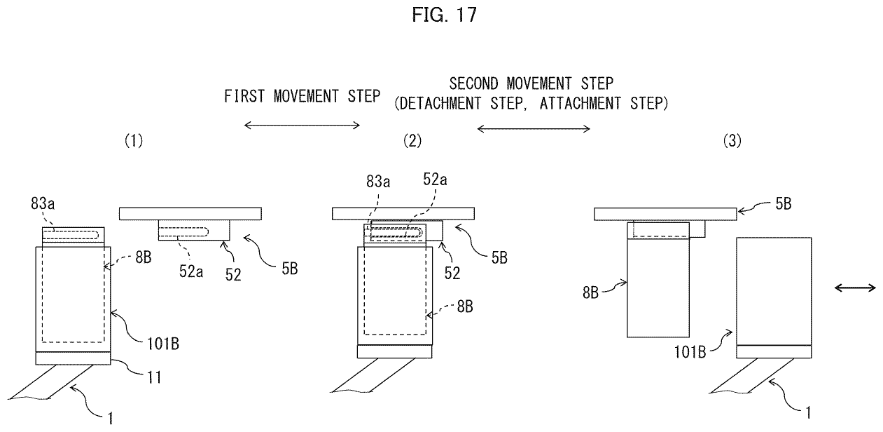

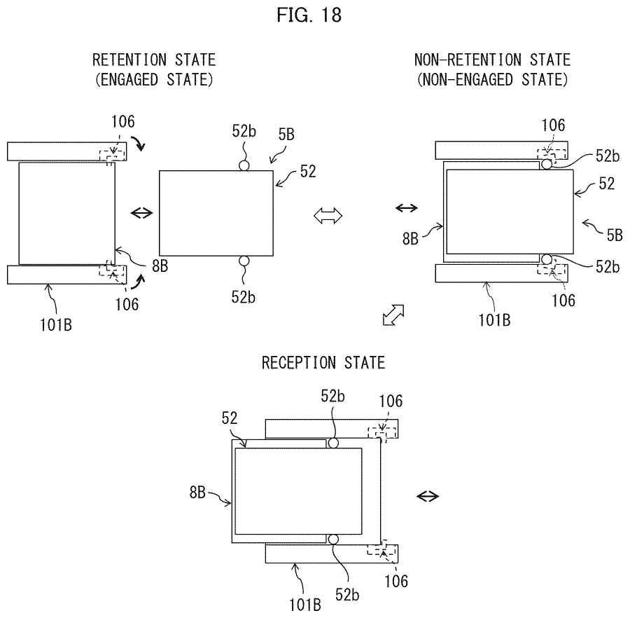

The following describes an operation of attaching and detaching the magazine 8B of the magazine attachment and detachment system 100 in accordance with Variation 2. FIG. 17 is side views illustrating an operation of attaching and detaching the magazine 8B to and from the retention body 101B of the retention mechanism 10B. FIG. 18 is plan views illustrating transitions between a retention state in which the magazine 8B is retained by the engagement mechanism 106, which engages with the magazine 8B, of the retention body 101B and a retention-released state in which retention of the magazine 8B by the engagement mechanism 106 is released. FIG. 19 is plan views illustrating, in further detail, transitions between a retention state in which the magazine 8B is retained by the engagement mechanism 106 and a retention-released state in which retention of the magazine 8B by the engagement mechanism 106 is released.

As illustrated in FIG. 17, the robot arm device 1 performs an operation of attaching the magazine 8B to and from the retention body 101B.

### (1) Non-Coupling Position

The magazine 8B is attached to the retention body 101B, and as illustrated on an upper left side of FIG. 18 and on a left side of FIG. 19, the attached state is fixed by the engagement mechanism 106, whereby the magazine 8B is retained by the retention body 101B (retention state). In this state, the retention body 101B is at a non-coupling position away from the hanger 5B, and the magazine 8B is not coupled to the hanger 5B. Further, the engagement mechanism 106 is in an engaged state in which the engagement piece 106a fits into the constricted part 81g and the engagement piece 106b abuts against the abutment part 81f.

### (2) Coupling Position

When the magazine 8B reaches a coupling position and is coupled to the hanger 5B, as illustrated on an upper right side of FIG. 18 and a middle part of FIG. 19, the engagement mechanism 106 moves from the fixation position to the non-fixation position, and the state in which the attachment of the magazine 8B is fixed by the engagement mechanism 106 is released. Thus, the magazine 8B is brought to a non-retention state in which the magazine 8B is not retained by the retention body 101B. In the non-retention state, the engagement mechanism 106 is in a non-engaged state in which, as a result of the engagement pieces 106a and 106b rotating from the retention state in arrow directions shown on the left side of FIG. 19, the engagement piece 106a escapes from the constricted part 81g and engagement with the magazine 8B cannot be maintained.

Further, at the coupling position, each projection 52b of the hanger 5B fits between the engagement pieces 106a and 106b. Thus, since the engagement mechanism 106 contacts not only the magazine 8B but also the hanger 5B via the projections 52b, reaction forces from the projections 52b are received, so that it is easier to rotate the engagement mechanism 106. Accordingly, detachment of the magazine 8B from the retention body 101B can be performed more reliably. This similarly applies to attachment of the magazine 8B to the retention body 101B.

Note that the hanger 5B need not include the projections 52b, and the engagement mechanism 106 of the retention body 101B need not protrude from the upper end of the retention body 101B so as to contact the projections 52b. However, in order to more reliably perform attachment and detachment of the magazine 8B to and from the retention body 101B, it is desirable that the hanger 5B includes the projections 52b and that the engagement mechanism 106 is provided at a position where the engagement mechanism 106 contacts the projection 52b.

### (3) Detachment Position

When the retention body 101B further moves from the coupling position, the retention body 101B reaches a detachment position at which the magazine 8B has been detached. In this state, as illustrated in lower part of FIG. 18 and on a right side of FIG. 19, the engagement pieces 106a and 106b of the engagement mechanism 106 further rotate under a force applied when the retention body 101B moves. As a result, the engagement piece 106a is oriented in a direction substantially orthogonal to the abutment part 81f, and the engagement piece 106b is oriented in a direction substantially parallel to the abutment part 81f. Thus, the engagement mechanism 106 enters a reception state of being able to receive the magazine 8B to be attached.

### First Movement Step

The control device 6 controls movement of the robot arm device 1 and moves the robot arm device 1 in a horizontal direction relative to the hanger 5B, thereby moving the retention body 101B on which the magazine 8B is attached between the coupling position and the non-coupling position. Through this, when the retention body 101B before replacement of the magazine 8B is moved from the non-coupling position to the coupling position, the magazine 8B becomes detachable from the retention body 101B (coupling step). Further, as described later, when the retention body 101B after replacement of the magazine 8B is moved from the coupling position to the non-coupling position, coupling of the magazine 8B by the hanger 5B is released (coupling release step).

### Second Movement Step

The control device 6 controls movement of the robot arm device 1 and moves the robot arm device 1 in the horizontal direction relative to the hanger 5B, thereby moving the retention body 101B between the coupling position and the detachment position. Through this, when the retention body 101B is moved from the coupling position to the detachment position, the magazine 8B is detached from the retention body 101B (detachment step). Further, when the retention body 101B is moved from the detachment position to an attachable position via a release preparation position and further moved in the same direction as in the first movement step until reaching the coupling position, the magazine 8B is attached to the retention body 101B (attachment step).

### Additional Remarks

The present invention is not limited to the embodiments above, but can be altered in various ways by a skilled person in the art within the scope of the claims. The present invention also encompasses, in its technical scope, any embodiment derived by appropriately combining technical means disclosed in differing embodiments.

Aspects of the present invention can also be expressed as follows:

As described above, a magazine attachment and detachment method in accordance with Aspect 1 of the present invention is a method for attaching and detaching a magazine to and from a retention body by a robot arm device provided with (i) the magazine in which an article to be supplied is loaded, (ii) a supply device that supplies the article from the magazine to a work device, (iii) the work device that performs work using the article, and (iv) the retention body that retains the magazine, the method including: a first movement step of moving the retention body between (i) a coupling position at which the magazine attached to the retention body is coupled to a coupling body that has a structure for coupling to the magazine and that is fixed at a predetermined position and (ii) a non-coupling position at which the magazine attached to the retention body is not coupled to the coupling body, by moving the robot arm device relative to the coupling body; and a second movement step of moving the retention body between the coupling position and a detachment position at which the magazine is detached from the retention body, by moving the robot arm device relative to the coupling body.

The robot arm device functions to move the work device to a required position for work and also includes the supply device. In the above method, with use of such a robot arm device, the magazine is moved to the coupling position so that the magazine is coupled to the coupling body, and the magazine is moved to the non-coupling position so that the magazine is no longer coupled to the coupling body. Further, the retention body is moved from the coupling position to the detachment position so that the magazine is detached from the retention body, and the retention body is moved from the detachment position to the coupling position so that the magazine is attached to the retention body.

In this manner, attachment and detachment of the magazine to and from the retention body is performed by movement of the robot arm device. Therefore, it is unnecessary to separately provide driving means for attaching and detaching the magazine. Accordingly, complication of the device configuration can be avoided.

A magazine attachment and detachment method in accordance with Aspect 2 of the present invention may be configured such that, in the above Aspect 1, the first movement step includes: a coupling step of moving the retention body from the non-coupling position to the coupling position; and a coupling release step of moving the retention body from the coupling position to the non-coupling position, and the second movement step includes: a detachment step of moving the retention body from the coupling position to the detachment position when the magazine is attached to the retention body; and an attachment step of moving the retention body from the detachment position to the coupling position when the magazine is detached from the retention body.

According to the above configuration, in the coupling step, the retention body is moved from the non-coupling position to the coupling position, so that the magazine retained by the retention body is coupled to the coupling body. From this state, in the detachment step, the retention body is moved to the detachment position, so that the magazine is detached from the retention body. In the state where the retention body is at the detachment position, the magazine coupled to the coupling body is replaced. Then, in the attachment step, the retention body is moved to the coupling position, so that the magazine is attached to the retention body. Further, in the coupling release step, the retention body is moved to the non-coupling position, so that coupling between the magazine and the coupling body is released. In this manner, the magazine can be replaced.

A magazine attachment and detachment method in accordance with Aspect 3 of the present invention may be configured such that, in the above Aspect 1 or 2, a remote direction in which the retention body moves away from the magazine and a proximity direction in which the retention body approaches the magazine in the second movement step are different from a coupling direction in which the magazine is coupled to the coupling body in the first movement step, and in the second movement step, when the retention body is moved from the coupling position to the detachment position, the retention body is moved in the remote direction, and when the retention body is moved from the detachment position to the coupling position, the retention body is moved in the proximity direction.

According to the above configuration, since the remote direction and the proximity direction differ from the coupling direction, the range of movement of the retention body can be narrowed compared with a case where the remote direction and the proximity direction are the same as the coupling direction. For example, in a case where the remote direction, the proximity direction, and the coupling direction are each a horizontal direction, the retention body moves widely in the horizontal direction. In contrast, in a case where the coupling direction is a horizontal direction whereas the remote direction is a downward direction and the proximity direction is an upward direction, the range of movement of the retention body in the horizontal direction can be narrowed.

A magazine attachment and detachment method in accordance with Aspect 4 of the present invention may be configured such that, in the above Aspect 1 or 2, in the first movement step, attachment of the magazine to the retention body is fixed when the retention body is at the non-coupling position, and fixation of attachment of the magazine to the retention body is released when the retention body is at the coupling position.

According to the above configuration, when the retention body is at the non-coupling position, the state in which the magazine is attached can be maintained so as to prevent the magazine from being detached from the retainer. Further, when the retention body is at the coupling position, the magazine can be detached from the retention body, so that it is possible to perform the detachment step or the attachment step.

A magazine attachment and detachment system in accordance with Aspect 5 of the present invention includes: a robot arm device provided with (i) a magazine in which an article to be supplied is loaded, (ii) a supply device that supplies the article from the magazine to a work device, (iii) the work device that performs work using the article, and (iv) a retention body that retains the magazine; a coupling body that has a structure for coupling to the magazine and is fixed at a predetermined position; and a control device that controls movement of the robot arm device relative to the coupling body so as to move the retention body between a coupling position at which the magazine attached to the retention body is coupled to the coupling body and a non-coupling position at which the magazine attached to the retention body is not coupled to the coupling body and move the retention body between the coupling position and a detachment position at which the magazine is detached from the retention body.

According to the above configuration, similarly in the magazine attachment and detachment method described above, attachment and detachment of the magazine to and from the retention body is performed by movement of the robot arm device. Therefore, it is unnecessary to provide driving means for attaching and detaching the magazine. Accordingly, complication of the device configuration can be avoided.

A magazine attachment and detachment system in accordance with Aspect 6 of the present invention may be configured such that, in the above Aspect 5, the magazine attachment and detachment system further includes: an attachment fixing member included in the retention body so as to be movable between a fixation position for fixing attachment of the magazine to the retention body and a non-fixation position for not fixing attachment of the magazine to the retention body, wherein in order to attach the magazine to the retention body, the control device moves the retention body at the detachment position to an attachable position at which the magazine is attachable to the retention body, and the attachment fixing member is at the fixation position in a state where the retention body is at the non-coupling position, and is at the non-fixation position in a state where the retention body is at the coupling position and the attachable position.

According to the above configuration, in a state where the retention body is at the non-coupling position, attachment of the magazine to the retention body is fixed by the attachment fixing member. Thus, regardless of an orientation in which the robot arm device moves, detachment of the magazine from the retention body can be prevented. Further, in states where the retention body is at the coupling position and the attachable position, an entrance/exit region of the retention body is not closed by the attachment fixing member. This enables the magazine to be detachable from the retention body at the coupling position, and to be attachable to the retention body at the attachable position.

### REFERENCE SIGNS LIST

1: Robot arm device
2: Nutrunner (work device)
3: Supply device
5, 5B: Hanger (coupling body)
6: Control device
7: Feed mechanism
8, 8B: Magazine
11: Support frame (distal end)
100: Magazine attachment and detachment system
101, 101B: Retention body
103: Projecting and retracting lock (attachment fixing member)
105: Slide lock (attachment fixing member)
106a, 106b: Engagement piece (attachment fixing member)
300: Bolt (article (to be) supplied)

1. A magazine attachment and detachment method for attaching and detaching a magazine to and from a retention body by a robot arm device provided with (i) the magazine in which an article to be supplied is loaded, (ii) a supply device that supplies the article from the magazine to a work device, (iii) the work device that performs work using the article, and (iv) the retention body that retains the magazine, the method comprising:
a first movement step of moving the retention body between (i) a coupling position at which the magazine attached to the retention body is coupled to a coupling body that has a structure for coupling to the magazine and that is fixed at a predetermined position and (ii) a non-coupling position at which the magazine attached to the retention body is not coupled to the coupling body, by moving the robot arm device relative to the coupling body; and
a second movement step of moving the retention body between the coupling position and a detachment position at which the magazine is detached from the retention body, by moving the robot arm device relative to the coupling body.

2. The magazine attachment and detachment method as set forth in claim 1, wherein
the first movement step includes: a coupling step of moving the retention body from the non-coupling position to the coupling position; and a coupling release step of moving the retention body from the coupling position to the non-coupling position, and
the second movement step includes: a detachment step of moving the retention body from the coupling position to the detachment position when the magazine is attached to the retention body; and an attachment step of moving the retention body from the detachment position to the coupling position when the magazine is detached from the retention body.

3. The magazine attachment and detachment method as set forth in claim 1, wherein
a remote direction in which the retention body moves away from the magazine and a proximity direction in which the retention body approaches the magazine in the second movement step are different from a coupling direction in which the magazine is coupled to the coupling body in the first movement step, and
in the second movement step, when the retention body is moved from the coupling position to the detachment position, the retention body is moved in the remote direction, and when the retention body is moved from the detachment position to the coupling position, the retention body is moved in the proximity direction.

4. The magazine attachment and detachment method as set forth in claim 1, wherein in the first movement step, attachment of the magazine to the retention body is fixed when the retention body is at the non-coupling position, and fixation of attachment of the magazine to the retention body is released when the retention body is at the coupling position.

5. A magazine attachment and detachment system, comprising:
a robot arm device provided with (i) a magazine in which an article to be supplied is loaded, (ii) a supply device that supplies the article from the magazine to a work device, (iii) the work device that performs work using the article, and (iv) a retention body that retains the magazine;
a coupling body that has a structure for coupling to the magazine and is fixed at a predetermined position; and
a control device that controls movement of the robot arm device relative to the coupling body so as to move the retention body between a coupling position at which the magazine attached to the retention body is coupled to the coupling body and a non-coupling position at which the magazine attached to the retention body is not coupled to the coupling body and move the retention body between the coupling position and a detachment position at which the magazine is detached from the retention body.

6. The magazine attachment and detachment system as set forth in claim 5, further comprising:
an attachment fixing member included in the retention body so as to be movable between a fixation position for fixing attachment of the magazine to the retention body and a non-fixation position for not fixing attachment of the magazine to the retention body, wherein
in order to attach the magazine to the retention body, the control device moves the retention body at the detachment position to an attachable position at which the magazine is attachable to the retention body, and
the attachment fixing member is at the fixation position in a state where the retention body is at the non-coupling position, and is at the non-fixation position in a state where the retention body is at the coupling position and the attachable position.
